(19) United States
(12) Patent Application Publication
(10) Pub. No.: US 2013/0247205 A1
(43) Pub. Date: Sep. 19, 2013

(54) CALCULATING QUANTITATIVE ASSET RISK

(71) Applicants: Sven Schrecker, San Marcos, CA (US); Stephen Ritter, Wilsonville, OR (US); Ryan Nakawatase, Laguna Hills, CA (US)

(72) Inventors: Sven Schrecker, San Marcos, CA (US); Stephen Ritter, Wilsonville, OR (US); Ryan Nakawatase, Laguna Hills, CA (US)

(73) Assignee: McAfee, Inc., Santa Clara, CA (US)

(21) Appl. No.: 13/183,259

(22) Filed: Jul. 14, 2011

Related U.S. Application Data
(60) Provisional application No. 61/364,383, filed on Jul. 14, 2010.

(51) Int. Cl. G06F 21/00

(52) U.S. Cl. 726/25

(57) ABSTRACT

Methods, systems, and apparatus, including computer programs encoded on computer storage media, for generating quantitative risk metrics for assets and threats. Risk metrics are generated for individual assets and individual threats. These individual metrics can then be analyzed to generate aggregate risk metrics for assets, groups of assets, and threats. Assets and threats can be ordered according to their aggregate risk metrics.

### CROSS-REFERENCE TO RELATED APPLICATIONS

This application claims the benefit under 35 U.S.C. §119(e) of U.S. Patent Application No. 61/364,383, titled “CALCULATING QUANTITATIVE ASSET RISK,” filed Jul. 14, 2010, the disclosure of which is incorporated here by reference.

### BACKGROUND

This specification relates to calculating risk metrics for assets in a system of assets.

An asset is a computer or other electronic device. A system of assets can be connected over one or more networks. For example, a home might have five assets, each of which are networked to each other and connected to the outside world through the Internet. As another example, a business might have three physically separate offices, each of which has many assets. The assets within each office and the assets across the offices can be connected over a network.

Each asset in a system of assets can be at risk from multiple threats at any given time. Each threat corresponds to a potential attack on the asset by a particular virus, malware, or other unauthorized entity. An attack occurs when the unauthorized entity exploits a known vulnerability of the asset in an attempt to access or control the asset. Some threats have known remediations that, if put in place for an asset, eliminate or reduce the risk that the threat will affect the asset. Some threats do not have known remediations.

### SUMMARY

In general, one innovative aspect of the subject matter described in this specification can be embodied in methods that include the actions of receiving threat definition data, the threat definition data including, for each of a plurality of threats, an identification of the threat, an identification of one or more countermeasures that reduce a risk that the threat will affect an asset, protection data describing a protection score for each countermeasure for the threat, and applicability data describing one or more configurations of assets to which the threat applies; receiving vulnerability detection data, countermeasure detection data, and configuration data for each of one or more assets, wherein the vulnerability detection data for each asset identifies threats to which the asset is vulnerable, the countermeasure detection data for each asset identifies one or more countermeasures protecting the asset, and the configuration data for each asset describes a configuration of the asset; and determining a respective risk metric for each of the one or more assets for each of the one or more threats, the determining including, for each asset and each threat: determining an applicability score for the asset and the threat from the applicability data and the configuration data, wherein the applicability score has a first applicability value when the threat is applicable to the configuration of the asset and a different second applicability value when the threat is not applicable to the configuration of asset; determining a vulnerability score for the asset and the threat from the vulnerability detection data for the asset, wherein the vulnerability score has a first vulnerability value when the asset is vulnerable to the threat, a second vulnerability value when the asset is not vulnerable to the threat, and a third vulnerability value when it is unknown whether the asset is vulnerable to the threat; determining a countermeasure score from the threat definition data and the countermeasure detection data, wherein the generating comprises analyzing the protection score for each countermeasure that is both identified in the threat definition data for the threat and identified in the countermeasure data as protecting the asset, wherein the countermeasure score has a value within a predefined range; and determining the risk metric for the particular asset for the particular threat from the applicability score, the vulnerability score, and the countermeasure score. Other embodiments of this aspect include corresponding systems, apparatus, and computer programs recorded on computer storage devices, each configured to perform the operations of the methods.

These and other embodiments can each optionally include one or more of the following features. The threat definition data can further includes a severity score for the threat, and wherein the risk metric is further determined from the severity score. The actions can further include receiving asset criticality data for each of the one or more assets, wherein the asset criticality data represents an impact of losing the asset; determining the respective risk metric for each of the one or more assets further comprises deriving a criticality score for each asset from the asset criticality data; and the risk metric is further determined from the criticality score. The criticality score can be derived from a monetary value of the asset. The criticality score can be derived from a business value of the asset. Determining the risk metric from the applicability score, the vulnerability score, and the countermeasure score can include: determining a threat factor from the applicability score; determining an exposure factor from the threat factor, the vulnerability score, and the countermeasure score; and determining the risk metric from the exposure factor.

The actions can further include determining a respective risk metric for the asset and each of a plurality of threats; and determining an aggregate risk metric for the asset from the respective risk metrics for the asset and each of the plurality of threats. The aggregate risk metric is one of: a sum of the respective risk metrics, a mean of the respective risk metrics, a maximum of the respective risk metrics, a minimum of the respective risk metrics, or a mode of the respective risk metrics. The actions can further include selecting a group of assets including the asset; determining an aggregate risk metric for each asset in the group of assets; and determining an aggregate risk metric for the group of assets from the aggregate risk metric for each asset in the group of assets. The actions can further include determining a respective risk metric for each of a plurality of assets and the threat; and determining an aggregate risk metric for the threat from the respective risk metrics for each of the plurality of assets and the threat.

The predefined range for the countermeasure score can be a discrete set of values. A threat can be an attack represented by an individual threat vector. A threat can correspond to multiple threat vectors. The risk metric can further be determined according to one or more user-specified weights.

In general, another innovative aspect of the subject matter described in this specification can be embodied in methods that include the actions of determining a threat factor for an asset and a threat, wherein the threat factor is derived from a threat severity score estimating a severity of the threat and an applicability score estimating the applicability of the threat to the asset; determining an exposure factor for the asset and the threat, wherein the exposure factor is derived from the threat factor, a vulnerability score, and a countermeasure component score, wherein the vulnerability score indicates whether the asset is vulnerable to the threat, not vulnerable to the threat, or of unknown vulnerability to the threat, and wherein the countermeasure component score is derived from an estimate of a likelihood that the countermeasure will mitigate the effect of an attack on the asset; and determining a risk metric for the asset and the threat from the exposure factor an a criticality score for the asset, wherein the criticality score represents an impact of losing the asset. Other embodiments of this aspect include corresponding systems, apparatus, and computer programs recorded on computer storage devices, each configured to perform the operations of the methods.

These and other embodiments can each optionally include one or more of the following features. The actions can further include receiving threat definition data, the threat definition data including an identification of the threat, an identification of one or more countermeasures that reduce a risk that the threat will affect an asset, a severity score for the threat, protection data describing a protection score for each countermeasure for the threat, and applicability data describing one or more configurations of assets to which the threat applies; and receiving vulnerability detection data, countermeasure detection data, configuration data, and criticality data for the asset, wherein the vulnerability detection data for the asset identifies threats to which the asset is vulnerable, the countermeasure detection data for the asset identifies one or more countermeasures protecting the asset, the configuration data for each asset describes a configuration of the asset, and the criticality data estimates a criticality of the asset. The actions can further include determining the threat severity score from the threat definition data. The actions can further include determining the applicability score from the applicability data and the configuration data. The actions can further include determining the countermeasure score from the threat definition data and the countermeasure detection data, wherein the determining includes analyzing the protection score for each countermeasure that is both identified in the threat definition data for the threat and identified in the countermeasure data as protecting the asset. The actions can further include determining the vulnerability score from the vulnerability detection data.

Particular embodiments of the subject matter described in this specification can be implemented so as to realize one or more of the following advantages. Users can visualize the magnitude of the risk of each threat on each asset. Users can compare the risk that different assets face. A quantitative metric can be used to standardize comparisons across assets and across asset systems. The metric is intuitive to a user. Individual risk scores for assets can be aggregated and analyzed to determine the risk within an asset system as a whole, or to determine the risk within groups of assets.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example asset system monitored by a network monitor.

FIG. 2 illustrates an example of the sources of data used by a network monitor.

FIG. 3 is a flow diagram of an example process for generating a risk metric for an asset and a threat.

FIG. 4 is a flow diagram of an example process for aggregating risk metrics for assets on a per-threat basis.

FIG. 5 is a flow diagram of an example process for aggregating risk metrics on a per-asset basis.

FIG. 6A is an example user interface presenting the top ten most at-risk assets according to the aggregate risk metric for the assets.

FIG. 6B is an example user interface presenting the top ten riskiest threats according to the aggregate risk metric for the threats.

Like reference numbers and designations in the various drawings indicate like elements.

### DETAILED DESCRIPTION

### §1.0 Asset System Overview

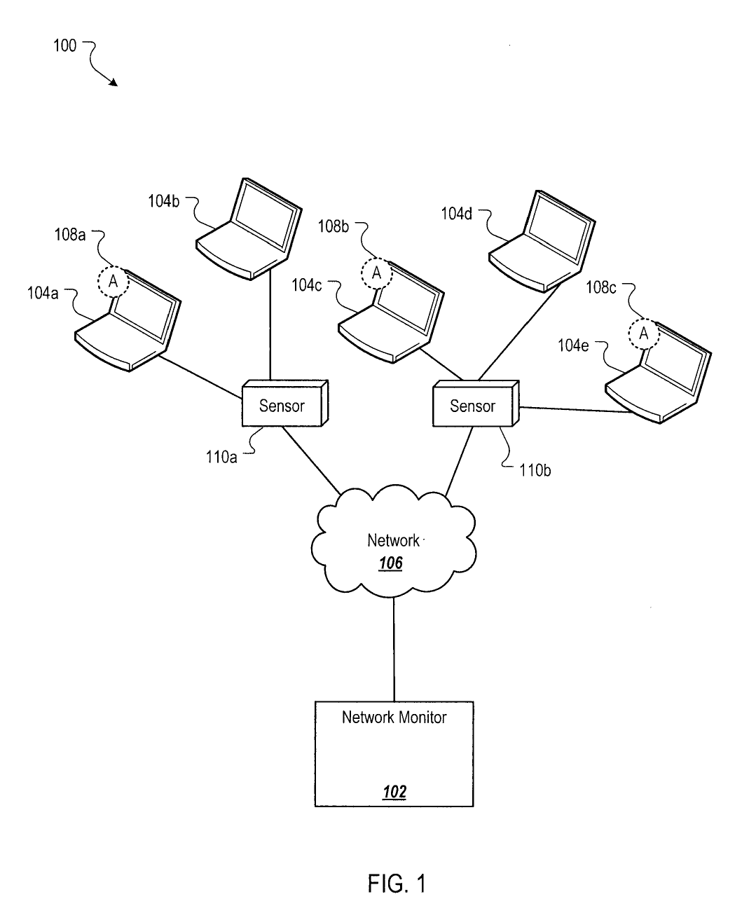

FIG. 1 illustrates an example asset system 100 monitored by a network monitor 102.

The assets 104 in the system 100 are connected to each other, and optionally to other systems, by a network 106.

Each asset 104 can be vulnerable to one or more threats. These threats include, for example, viruses, malware, and other software or agents that cause unauthorized attacks. Each asset can be protected by a variety of countermeasures. These countermeasures include passive countermeasures and active countermeasures.

Passive countermeasures are provided by two kinds of sensors: agent-based sensors 108 and network-based sensors 110. The agent-based sensors 108 and the network based sensors 110 monitor the assets themselves and/or network traffic to and from the assets. For illustrative purposes, the sensors are described below as both monitoring the assets and protecting the assets by providing one or more countermeasures. However, the monitoring and countermeasure functionalities do not have to be provided by the same sensor. In the description below, sensor is used to refer to various types of monitoring and protection systems including, for example, firewalls, host intrusion prevention systems, network intrusion prevention systems, network access control systems, intrusion detection systems, intrusion prevention systems, anti-virus software, and spam filters.

The agent-based sensors 108 and the network-based sensors 110 can include one or more passive countermeasures that are part of the sensor. These passive countermeasures are software programs and/or hardware that protect assets from various threats. Each passive countermeasure reduces the risk that a threat will affect an asset. A passive countermeasure protects against a threat by detecting and stopping an attack associated with the threat, by detecting and stopping activities associated with the attack, or by mitigating damage caused by an attack. For example, a passive countermeasure may be configured to detect data having a signature associated with a particular attack, and block data with that signature. As another example, a passive countermeasure may generate back-up copies of particular files targeted by an attack, so that even if the attack attacks the files, the files can be restored. Example passive countermeasures include, but are not limited to, hardware firewalls, software firewalls, data loss prevention systems, web proxies, mail filters, host-based intrusion prevention systems, network-based intrusion prevention systems, rate-based intrusion prevention systems, content-based intrusion prevention systems, intrusion detection systems, and virus detection software.

Passive countermeasures can also be partial countermeasures that do not completely protect from or mitigate the effects of an attack. For example, a partial passive countermeasure might block some, but not all, of the network traffic associated with a particular attack. As another example, if a threat needs either direct physical access or network access to compromise an asset, an example partial passive countermeasure would block network access to the asset, but not physical access.

The agent-based sensors 108 are software-based sensors that are installed on respective assets 104. For example, agent-based sensor 108a is installed on asset 104a, agent-based sensor 108b is installed on asset 104c, and agent-based sensor 108c is installed on asset 104e. The agent-based sensors 108 run various analyses on their respective assets 104, for example, to identify vulnerabilities on the assets 104 or to identify viruses or other malware executing on the assets 104. The agent-based sensors may also provide one or more passive countermeasures for threats, as described above. Example agent-based sensors include antivirus software.

The network-based sensors 110 are hardware devices and/or software in a data communication path between assets 104 protected by the sensor and the network resources that the asset is attempting to access. For example, sensor 110a is connected to assets 104a and 104b, and sensor 110b is connected to assets 104c, 104d, and 104e. While FIG. 1 illustrates a single network-based sensor 110 in a communication path with each asset, other configurations are possible. For example, multiple network-based sensors 110 can be connected to the same asset 104, and some assets 104 may not be connected to any network-based sensors 110.

When an asset 104 tries to send information through the network 106 or receive information over the network 106 through a network-based sensor 110, the sensor analyzes information about the asset 104 and the information being sent or received and determines whether to allow the communication. An example network-based sensor includes one or more processors, a memory subsystem, and an input/output subsystem. The one or more processors are programmed according to instructions stored in the memory subsystem, and monitor the network traffic passing through the input/output subsystem. The one or more processors are programmed to take one or more protective actions on their own, or to query a sensor control system (not shown) and take further actions as instructed by the sensor control system 102. Example network-based sensors include network access control systems, firewalls, routers, switches, bridges, hubs, web proxies, application proxies, gateways, network access control systems, mail filters, virtual private networks, intrusion prevention systems and intrusion detection systems.

The assets 104 can also be protected by one or more active countermeasures that are applied to the asset. Active countermeasures make changes to the configuration of assets or the configuration of existing passive countermeasures to actively eliminate a vulnerability. In contrast, passive countermeasures hide the effects of a vulnerability, but do not remove the vulnerability. Each active countermeasure eliminates, or at least reduces, the risk that a threat will affect an asset when the active countermeasure is applied to the asset by eliminating, or at least reducing, a vulnerability. An active countermeasure protects against a threat by modifying the configuration of an asset 104 so that the asset is no longer vulnerable to the threat. For example, an active countermeasure can close a back door that was open on an asset or correct another type of system vulnerability. Example active countermeasures include, but are not limited to, software patches that are applied to assets.

The assets 104 may be vulnerable to many different threats at any given time. Some of the assets 104 may be already protected by one or more passive countermeasures, and some of the assets 104 may need to have additional countermeasures put in place to protect the assets from the threats. Therefore, it is helpful to determine a risk metric for each asset and each threat. The risk metric is a quantitative measure of the risk that a threat poses to an asset, both in terms of the probability that the threat will affect the asset and the magnitude of the effect that the threat will cause.

The network monitor 102 is one or more computers, each of which includes one or more processors, a memory subsystem, and an input/output subsystem. The network monitor 102 is programmed to process data about potential threats on the network, as well as countermeasures provided by the sensors and vulnerabilities of the assets, in order to generate risk metrics for assets and threats. The network monitor 102 can also aggregate risk metrics across the system.

Risk metrics, and example techniques for generating and aggregating risk metrics, are described in more detail below.

### §2.0 Example Data Sources for Risk Metric Generation

The network monitor 102 receives data from several sources in order to determine a risk metric for a given asset and a given threat.

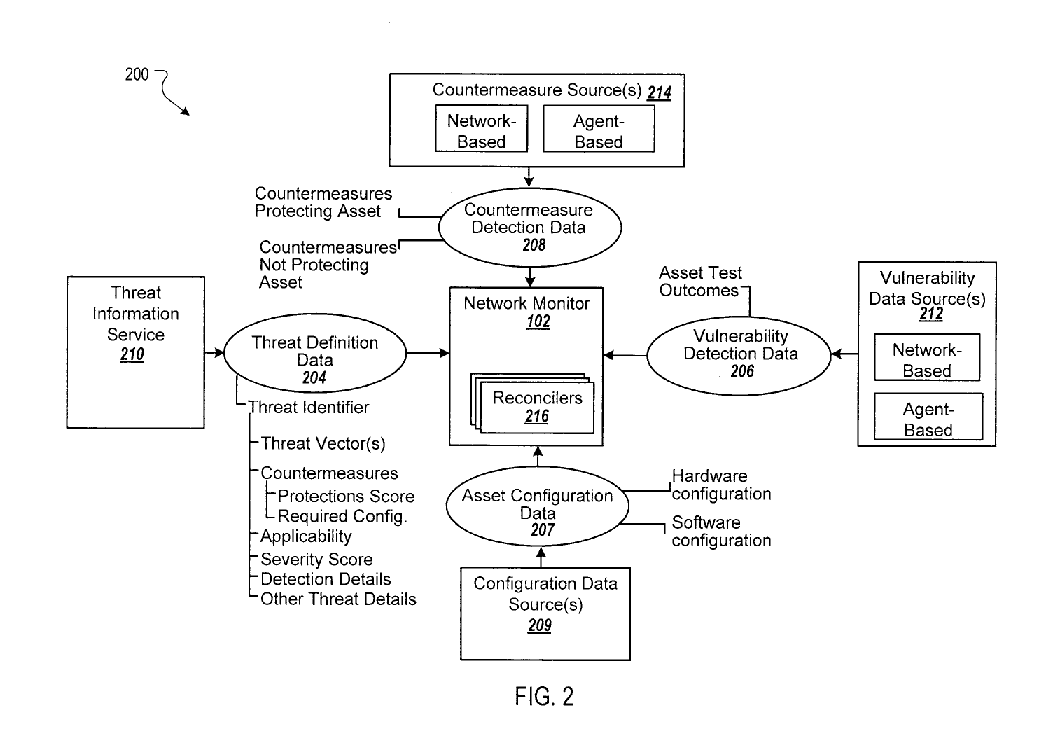

FIG. 2 illustrates an example of the sources of data used by a network monitor 102. The network monitor 102 receives one or more of threat definition data 204, vulnerability detection data 206, asset configuration data 207, and countermeasure detection data 208. The threat definition data describes identified threats, what countermeasures (if any) protect assets from the threats, and the severity of the threat. The vulnerability detection data 206 specifies, for each asset and for each threat, whether the asset is vulnerable to the threat, not vulnerable to the threat, or of unknown vulnerability. The configuration data 207 specifies, for each asset, details of the configuration of the asset. The countermeasure detection data 208 specifies, for each asset, what countermeasures are protecting the asset.

§2.1.1 Asset Configuration Data

The asset configuration data 207 is received from one or more configuration data source(s) 209. In some implementations, the configuration data source(s) 209 are one or more data aggregators. A data aggregator is one or more servers that receive configuration data, aggregate the data, and format the data in a format useable by the network monitor 102. The data aggregators can receive configuration data from the assets themselves or from the sensors monitoring the assets. Example data aggregators include McAfee ePolicy Orchestrator®, available from McAfee of Santa Clara, Calif., and Active Directory®, available from Microsoft Corporation of Redmond, Wash. For example, a data aggregator can maintain an asset data repository with details on asset configurations. Alternatively, the configuration data source(s) 209 are the assets and/or sensors themselves. When the configuration data source(s) 209 are the assets and/or sensors themselves, the configuration data is not aggregated when it is received by the network monitor 102, and the network monitor 102 aggregates the data itself.

The configuration of an asset is a hardware and/or software configuration. Depending on the configuration, various threats may be applicable to an asset. In general, the configuration of the asset can include one or more of the physical configuration of the asset, the software running on the asset, and the configuration of the software running on the asset. Examples of configurations include particular families of operating systems (e.g., Windows™, Linux™, Apple OS™), specific versions of operating systems (e.g., Windows Vista™), particular network port settings (e.g., network port 8 is open), and particular software products executing on the system (e.g., a particular word processor or a particular web server). In some implementations, the configuration data does not include countermeasures in place for the asset, or whether the asset is vulnerable to a particular threat.

§2.1.2 Threat Definition Data

The threat definition data 204 is received from a threat information service 210. The threat information service 210 identifies threats and countermeasures that protect against the threats, and then provides the data to the network monitor 102. In some implementations, the threat information service 210 can provide a threat feed with the threat definition data to the network monitor 102 through a network. The threat feed can be, for example, threat definition data sent over the network either as needed, or according to a predefined schedule.

The threat definition data 204 identifies one or more threats. The threat definition data 204 can further specify one or more threat vectors for each threat. Each threat vector represents a vulnerability exploited by the threat and how the vulnerability is exploited, e.g., represents a particular attack associated with the threat. In some implementations, multiple threat vectors for a threat are aggregated into a single threat vector representing the entire threat. In other implementations, the individual threat vectors for a threat are separately maintained. As used herein, threat means either an attack represented by a single threat vector, or an overall threat represented by one or more threat vectors.

The threat definition data 204 further specifies, for each threat, the countermeasures that protect against the threat and a protection score for each countermeasure. In general, the protection score estimates the effect that the countermeasure has on mitigating the threat. The protection score for each countermeasure has a value in a predetermined range. Values at one end of the range (e.g., the low end) indicate that the countermeasure provides a low level of mitigation. Values at the other end of the range (e.g., the high end) indicate that the countermeasure provides a high level of mitigation.

Consider an example where the protection scores range from zero to one-hundred. The information service 210 can define the protection scores as follows. A countermeasure has a protection score of zero for a threat when the countermeasure does not cover the threat, the threat is out of the scope of the countermeasure, the coverage of the countermeasure is pending, the coverage of the countermeasure is undermined by something else executing on the asset, when coverage is not warranted, or when the coverage of the countermeasure is under analysis. A countermeasure has a protection score of 50 when the countermeasure provides partial coverage for the asset. Partial countermeasures that provide partial coverage for the asset are described in more detail below with reference to §2.1.4. A countermeasure has a protection score of 100 when the countermeasure is expected to, or actually does, provide full coverage from the threat. Other scales, and other discretizations of the protection score can alternatively be used.

The data specifying the countermeasures that mitigate the effect of a threat can also include required system settings for the particular configurations of the countermeasures. For example, these settings can include a version of a signature file that must be used by a software product, or can include a product identifier, a product version identifier, and data describing other settings of the software product. The data can also identify some of the countermeasures as partial countermeasures. In some implementations, the threat definition data 204 also includes a countermeasure confidence score for each countermeasure that protects against the threat. The confidence score is an estimate of how likely the countermeasure is to reduce the risk that the threat or the threat vector will affect the asset.

The threat definition data 204 also includes applicability data for each threat. The applicability data specifies a configuration that an asset must have in order to be vulnerable to the threat. For example, the applicability data can specify that the threat only attacks particular operating systems or particular software products installed on an asset, or that the threat only attacks particular versions of products, or products configured in a particular way.

The threat definition data 204 can also include a severity score for the threat. The severity score is an estimate of how severe an attack by the threat would be for an asset, and may optionally also estimate how likely the threat is to affect assets. The severity score can be calculated according to multiple factors including, for example, a measure of how a vulnerability is exploited by a threat; the complexity of an attack once the threat has gained access to the target system; a measure of the number of authentication challenges typically determined during an attack by a threat; an impact on confidentiality of a successfully exploited vulnerability targeted by the threat; the impact to the integrity of a system of a successfully exploited vulnerability targeted by the threat; and the impact to availability of a successfully exploited vulnerability targeted by the threat. The severity score can be specified by a third party or determined by the information source. For example, the severity score can be received from products provided by McAfee of Santa Clara, Calif.

In some implementations, the threat definition data 204 also specifies which sensors and/or which software products executing on the sensors can detect an attack corresponding to the threat. For example, suppose threat A can attack all machines on a network with a specific vulnerability and that product B can detect the vulnerability when it has setting C. Furthermore, product D provides passive countermeasures that mitigate the effect of the threat. In this case, the threat definition data can specify that threat A attacks all machines, that product B with setting C can detect the vulnerability to the threat, and that product D provides passive countermeasures that protect against the threat.

The threat definition data 204 can also optionally include other details for the threat, for example, whether the existence of the threat has been made public, who made the existence of the threat public (e.g., was it the vendor of the software that has been compromised?), a web address for a public disclosure of the threat, and one or more attack vectors for the threat. The attack vectors can be used to determine what passive countermeasures are protecting the asset from the threat at a given time.

The threat definition data may also include other information about the threat, for example, a brief description of the threat, a name of the threat, an estimate of the importance of the threat, an identifier of the vendor(s) whose products are attacked by the threat, and recommendations on how to mitigate the effects of the threat.

In some implementations, the threat definition data has a hierarchical structure (e.g., multiple tiers). For example, the first tier can include a general identification of the products that are vulnerable to the threat such as the name of a software vendor or the name of a particular product vulnerable to the threat. Additional tiers can include additional details on needed configurations of the assets or other details of the threat, for example, particular product versions or settings including the applicability data described above.

§2.1.3 Vulnerability Detection Data

The vulnerability detection data 206 is received from one or more vulnerability data source(s) 212. In some implementations, the vulnerability data source(s) 212 are one or more data aggregators. The data aggregators receive vulnerability detection data from individual sensors in the system. The individual sensors can be agent-based sensors and/or network-based sensors. A data aggregator is one or more servers that receive configuration data, aggregate the data, and format it in a format useable by the network monitor 102. The data aggregators can be the same as, or different from, the data aggregators that are the configuration data source(s) 209. The data aggregators can receive vulnerability data from the assets themselves or from the sensors monitoring the assets. An example data aggregator is McAfee ePolicy Orchestrator®, available from McAfee® of Santa Clara, Calif. Alternatively, the vulnerability data source(s) 212 can be the assets and/or sensors themselves. When the vulnerability data source(s) 212 are the assets and/or sensors themselves, the vulnerability data is not aggregated when it is received by the network monitor 102, and the network monitor 102 aggregates the data itself.

The vulnerability detection data 206 for a given asset specifies what tests were run by sensors protecting the asset, as well as the outcome of those tests. Example tests include virus scans, vulnerability analyses, system configuration checks, policy compliance checks, network traffic checks (e.g., provided by a firewall, a network intrusion detection system, or a network intrusion prevention system), and tests performed by host-based intrusion prevention systems or host-based intrusion detection systems. The vulnerability detection data 206 allows the network monitor 102 to determine, in some cases, that an asset has one or more vulnerabilities that can be exploited by a threat, and to determine, in other cases, that the asset does not have any vulnerabilities that can be exploited by the threat. Some threats exploit only a single vulnerability, while other threats exploit multiple vulnerabilities, as will be described in more detail below with reference to §3.0.

Multiple sensors may test for the same vulnerability. In that case, the vulnerability detection data 206 can include the outcome of all of the tests for the vulnerability (optionally normalized, as described below). Alternatively, the vulnerability detection data 206 may include the outcome for only a single test, for example, a test that found the asset vulnerable or a test that found the asset not vulnerable.

In some implementations, when an asset may have a vulnerability that has been corrected by an active countermeasure, for example, a software patch, the tests will indicate that the asset is not vulnerable to the threat, as the countermeasure has stopped the vulnerability.

§2.1.4 Countermeasure Detection Data The countermeasure detection data 208 is received from countermeasure source(s) 214. In general, the countermeasure detection data 208 specifies, for a given asset, what countermeasures are in place to protect the asset. In some implementations, the countermeasure detection data 208 also specifies what countermeasures are not protecting the asset. A countermeasure is not protecting an asset, for example, when it is not in place at all, or when it is in place to protect the asset but is not properly configured.

The countermeasure source(s) 214 are sources that store the settings of individual sensors in the network, as well as data specifying which assets are protected by which sensors. For example, the countermeasure source(s) 214 can be one or more computers that receive data about the protection provided by sensors in the network and data about which sensors protect which assets. The countermeasure source(s) 214 aggregate the data to determine which countermeasures are in place to protect each asset. An example countermeasure data source is McAfee ePolicy Orchestrator®, available from McAfee® of Santa Clara, Calif. Example settings include an identification of the product providing the countermeasure, a product version, and product settings. Other example settings include one or more signatures of threats (e.g., file signatures or network traffic signatures) that are blocked by the countermeasure.

Countermeasures can be provided by the network-based sensors in the network, the agent-based sensors in the network or both. When a countermeasure is provided by an agent-based sensor running on the asset, it is clear that the countermeasure is protecting the asset. However, network-based countermeasures are remote from the assets they are protecting. Therefore, additional data is needed to associate network-based passive countermeasures with the assets they protect. The countermeasure source(s) 214 must first determine which assets are monitored by which network-based sensors, and then associate, for each sensor, the passive countermeasures provided by the sensor with each of the assets monitored by the sensor. Users can manually associate the assets with the sensors, or the assets can be automatically associated with the sensors.

In some implementations, users manually associate assets with sensors through various user interfaces. For example, one user interface allows users to manually specify the identity of each asset protected by each sensor in the network. Alternatively, users can be presented with a user interface that allows them to specify a series of rules for associating assets with sensors. The rules can be based, for example, on Internet Protocol (IP) address ranges, nodes through which assets connect to the network, Media Access Control (MAC) address ranges, NetBIOS names of assets, or other user-specified categories, such as groups of assets defined by users or properties of assets tagged by users.

In other implementations, the countermeasure source(s) 214 can automatically correlate sensors with assets based on alerts received from the sensors. Each alert identifies an attack on an asset that was detected by the sensor. For example, when a sensor detects an attack on a particular IP address, the countermeasure source(s) 214 can determine that the sensor is protecting an asset with that particular IP address.

In some implementations, the data associating sensors with assets can associate a sub-part of the sensor with the asset, when that sub-part protects the asset. For example, if a particular port on a network-based sensor, or a particular software program running on a sensor, protects an asset, the association can further specify the port or software program.

§2.1.5 Normalizing and Reconciling the Data

The data described above is received from different sources and is not necessarily in the same format. For example, each source can identify threats, countermeasures, and assets using different naming conventions. Therefore, the network monitor 102 may have to normalize the data before it can be used. The network monitor 102 normalizes the data by using source-specific reconcilers 216 that format the data received from a given source into a standard format. For example, an enterprise may receive data from two products, product A and product B. Product A may provide the data in one format, and product B may provide the data in a different format. The network monitor 102 uses a reconciler specific to product A to translate the data from Product A into a format that can be used by the network monitor 102. Similarly, the network monitor 102 uses a reconciler specific to product B to translate the data from product B into a format that can be used by the network monitor 102. Each source-specific reconciler can be, for example, one or more computers or one or more software programs on one or more computers. Each source-specific reconciler 216 translates the data, for example, using a corresponding table that maps identifiers used by the specific source to identifiers used by the network monitor 102.

### §3.0 Example Process for Risk Metric Generation

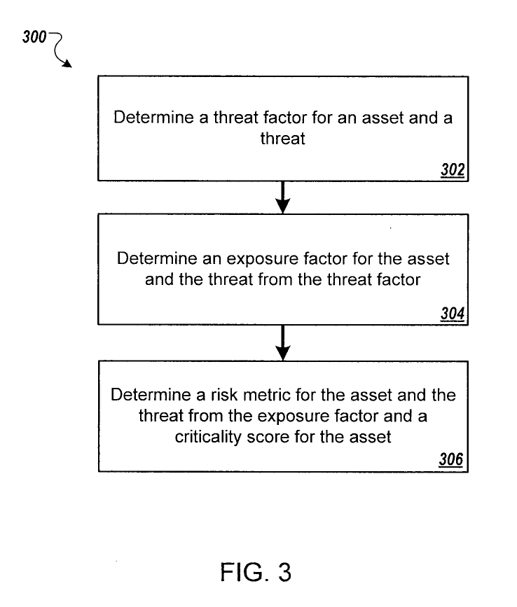

FIG. 3 is a flow diagram of an example process 300 for generating a risk metric for an asset and a threat. As used herein, the threat can be a particular attack represented by an individual threat vector for a threat, or can be the threat as a whole. The process can be implemented, for example, by the network monitor 102.

The process 300 determines a threat factor T for an asset and a threat (302). The threat factor is derived from a threat severity score T_{S} for the threat and applicability score A_{P} for the threat.

In some implementations, the system determines the threat factor for an asset and a threat as follows. The system determines the threat severity score T_{S} for the threat, determines the applicability score A_{P} for the threat, and multiplies the threat severity score by the applicability score, e.g.,: T=T_{S}A_{P}.

The threat severity score T_{S} is specified in the threat definition data 204 described above with reference to FIG. 2. In general, the threat severity score T_{S} has a value in a pre-determined range of values. For example, the threat severity score T_{S} can have a value between 0.0 and 10.0, in 0.1 increments. In some implementations, when the threat is represented by multiple threat vectors, each threat vector can have an individual severity score. In these implementations, the process 300 can derive the threat severity score from the individual severity scores. For example, the process 300 can use the maximum individual threat severity score, or the average individual threat severity score, as the threat severity score.

The applicability score A_{P} for an asset has a first value (e.g., one) when a threat is applicable to an asset, and has a second value (e.g., zero) when the threat is not applicable to the asset. A threat is applicable to an asset when the asset is running software that is of a type that can have a vulnerability that is exploited by the threat or when the asset contains hardware that can have a vulnerability that is exploited by the threat. For example, if a particular operating system has a known vulnerability that is exploited by a threat, and an asset is running that operating system, the threat is applicable to the asset. This is true regardless of whether the operating system on the asset has the vulnerability, or has been remediated to remove the vulnerability.

The process 300 compares applicability data for a given threat to configuration data for a given asset to determine whether the given threat is applicable to the given asset. The applicability data and configuration data are described in more detail above, with reference to FIG. 2. When the applicability data matches the configuration data, the process 300 determines that the threat is applicable to the asset, and therefore the applicability score is the first value (e.g., one). Conversely, when the applicability data does not match the configuration data, the process 300 determines that the threat is not applicable to the asset, and therefore the applicability score is the second value (e.g., two). If the process cannot determine whether the threat is applicable to the asset, for example, because applicability data or configuration data is not available, the applicability score is the first value (e.g., one).

In some implementations, the process 300 determines that a threat is applicable to an asset when the applicability data for the threat specifies a configuration that exactly matches the configuration of the asset. In other implementations, the process 300 determines that a threat is applicable to an asset when the configuration specified by the applicability data only partially matches the configuration of the asset. The configuration specified by the applicability data partially matches the configuration of the asset when some aspect of the configuration specified in the applicability data matches the configuration data for the asset, but some other aspect does not. For example, the process 300 can determine that the applicability data for a threat partially matches the configuration of an asset when the operating system targeted by the threat and the operating system running on the asset are in the same family, but not identical operating systems.

In some implementations, when the threat is represented by multiple threat vectors, each threat vector can have individual applicability data. In these implementations, the process 300 can determine individual applicability scores for each threat vector and then derive the applicability score from the individual applicability scores. For example, the process 300 can use the maximum individual applicability score, or the average individual applicability score, as the applicability score.

The process 300 determines an exposure factor E for the asset and the threat (304). The exposure factor E estimates the risk that an asset will be affected by the threat, and is derived from the threat factor T, a vulnerability score V, and a countermeasure score C. In some implementations, the exposure factor E is proportional to the threat factor T and the vulnerability score V and inversely proportional to the countermeasure score C. For example, the exposure factor can be calculated as follows:

$$E = \frac{TV}{C} .$$

The vulnerability score estimates whether the asset is vulnerable to the threat. An asset is vulnerable to a threat when the asset is running software that has a known vulnerability that can be exploited by the threat, and the problem has not been patched or otherwise remediated. In general, the vulnerability score has one of three pre-determined values. When the asset is vulnerable to the threat, the vulnerability score has a first value (e.g., one). When the asset is not vulnerable to the threat, the vulnerability score has a different second value (e.g., zero). When it is unknown whether the asset is vulnerable to the threat, the vulnerability score has a different third value (e.g., one-half).

The process 300 determines whether the asset is vulnerable to a threat by analyzing the vulnerability detection data to determine whether any test whose outcome is included in the vulnerability detection data identified the asset as being vulnerable to the threat. If so, the process 300 determines that the asset is vulnerable to the threat, and the vulnerability score V should have the first value (e.g., one). If not, the process 300 next analyzes the data to determine whether any test identified the asset as being not vulnerable to the threat. If so, the process 300 determines that the asset is not vulnerable to the threat, and the vulnerability score V should have the second value (e.g., zero). Finally, if no test whose outcome is included in the vulnerability detection data identified the asset as being vulnerable or not vulnerable to the threat, the process 300 determines that the asset's vulnerability is unknown, and that the vulnerability score should have the third value (e.g., one-half).

In some implementations, a given threat can exploit multiple vulnerabilities in the software of an asset. In these implementations, the process 300 can use the maximum value for the vulnerability score for each vulnerability as the vulnerability score. For example, if the threat could attack vulnerability A and vulnerability B of the asset, the vulnerability score for vulnerability A is one-half and the vulnerability score for vulnerability B is one, the process could use one as the vulnerability score for the asset. Other heuristics, for example, using the mean or median score, can alternatively be used. In some implementations, each possible exploitation of a vulnerability is represented as a separate threat vector.

The countermeasure score estimates a level of protection provided to the asset by any countermeasures protecting the asset. The process 300 selects the countermeasure score from a predetermined range, for example, from zero to ten. In some implementations, the countermeasure score is one of a discrete number of values within the range. For example, the countermeasure score can have a first value if the countermeasure(s) provide full mitigation, a different second value if the countermeasure(s) provide partial mitigation, and a different third value if the countermeasure(s) provide no mitigation or unknown mitigation.

To determine the appropriate countermeasure score for an asset and a threat, the system first determines what countermeasures for the threat are protecting the asset, and then determines the countermeasure score from protection scores for the countermeasures that are in place. In some implementations, the process 300 determines what countermeasures for the threat are in place from the threat definition data and the countermeasure detection data, and determines whether an asset is protected by countermeasures for a threat by identifying the countermeasures for the threat specified in the threat definition data for the threat, and also identifying the countermeasures protecting the asset from the countermeasure detection data. The process 300 then determines whether any of the countermeasures for the threat are protecting the asset. As part of this determination, the process compares required settings of the countermeasures specified in the threat definition data to actual settings of the countermeasures specified in the countermeasure detection data.

If there are no countermeasures for the threat that are protecting the asset (or the asset's countermeasure state is unknown), the countermeasure score is assigned a value at the low-end of the predetermined range (e.g., zero from a range from zero to ten).

If there is at least one countermeasure for the threat that is protecting the asset, the system retrieves the protection score for each countermeasure from the threat definition data and calculates the countermeasure score from the protection scores.

In some implementations, the system uses the maximum of the protection scores as the countermeasure score for the asset. However, other calculations can also be used; for example, the system can use the mean or minimum of the protection scores.

In some implementations, the system further scales the countermeasure score so that it is consistent with the range of values used for the other scores. For example, if the threat severity is measured on a scale of zero to ten, and the countermeasure score ranges from zero to one-hundred, the system can scale the countermeasure score by dividing it by ten. In some implementations, the system converts a countermeasure score of zero to a countermeasure score of one, to avoid possible division by zero in the risk metric calculations.

The process 300 determines a risk metric for the asset and the threat from the exposure factor E and a criticality score A for the asset (306). In some implementations, the system determines the risk metric by multiplying the exposure factor E and the criticality score A, e.g., EA.

The criticality score represents an impact of losing an asset. In some implementations, the criticality of an asset is derived from a monetary value of an asset, e.g., an estimate of the monetary cost of replacing the asset. Alternatively or additionally, the criticality of an asset can be derived from a business value of the asset, e.g., an importance of the asset to the overall asset system. The criticality score can have a value in a pre-determined range, e.g., from zero to ten. As another example, the criticality score can be selected from the set {2, 4, 6, 8, 10} where higher values indicate higher criticality.

The process 300 can determine the criticality score of an asset in various ways. In some implementations, users specify the criticality of individual assets, or groups of assets, for example, through a user interface. In some implementations, the assets in the system are represented in a hierarchical tree; in these implementations, a user can identify a group of assets by selecting a particular level in the hierarchy. All assets at the selected level or below the selected level in the hierarchy are considered a group, and can have a user-specified criticality. The user can specify a numerical value for the criticality score, or a criticality categorization (e.g., low, medium, high, extremely high) that is then mapped to a numerical value by the process 300.

In some implementations, users assign tags to individual assets, and then specify criticality for particular tags. For example, a user could tag some assets as mail servers and some assets as web servers, and then specify that mail servers have one criticality and web servers have a different criticality.

In some implementations, the process 300 determines the criticality of an asset from user-defined rules that specify how criticality should be determined. For example, users can specify that assets that are running a particular operating system and that have an IP address in a certain range should have one criticality, while assets in a different IP range should have a different criticality. In some implementations, the process 300 imports the criticality of the assets from a separate asset management system.

In some implementations, an asset can have multiple criticalities depending on how it is grouped. For example, an asset that is a mail server in a particular office in California can be grouped into one group because it is a mail server, another group because it is in the particular office in California, and another group because it is in North America. Assets can be grouped according to physical, logical, or user-specified criteria. An appropriate criticality can be selected given one or more rules maintained by the network monitor 102 or another system executing the process.

While the above describes particular combinations of scores to generate the threat factor and the exposure factor, fewer or more scores can also be used.

§3.1 User Configuration of Risk Metric Generation

In some implementations, the network monitor 102 allows a user to specify weights for one or more of the scores or factors used to generate the risk metric. For example, a user can specify that the criticality should be given a particular weight, can specify that the vulnerability should be given a particular weight, or can specify that the exposure factor should be given a particular weight. Users can specify weights for multiple scores or factors. Weights of zero effectively remove a score or factor from the risk metric calculation. Users can also use the weights to increase the effect of a score or factor, or to decrease the effect of a score or factor.

In some implementations, when the network monitor 102 allows users to use weights, the network monitor rebalances the resulting risk metric so that it is in the same range as an unweighted risk metric would have been. For example, if a user specified that the asset criticality should be given a weight of 2, the network monitor 102 would divide the resulting metric by 2.

In some implementations, users can specify different weights for different categories of threats or assets. For example, a user could specify a first weight for threats that attack assets running one specific type of operating system, and could specify a different second weight for threats that attack assets running a different type of operating system.

### §4.0 Example Processes for Aggregating Risk Metrics

Section 3.0 describes calculating a risk metric for an individual asset and an individual threat. However, system administrators, and other users, often want to gain an overall view of their systems. Therefore, aggregating the risk metrics on a per-threat basis, a per-asset basis, and per-asset group basis allows the network monitor to provide such a function. These aggregate metrics can help system administrators determine which metrics, and which threats, pose the most serious problems for a system. Each of these aggregate risk metrics is described in more detail below.

§4.1 Example Process for Aggregating Risk Metrics on a Per-Threat Basis

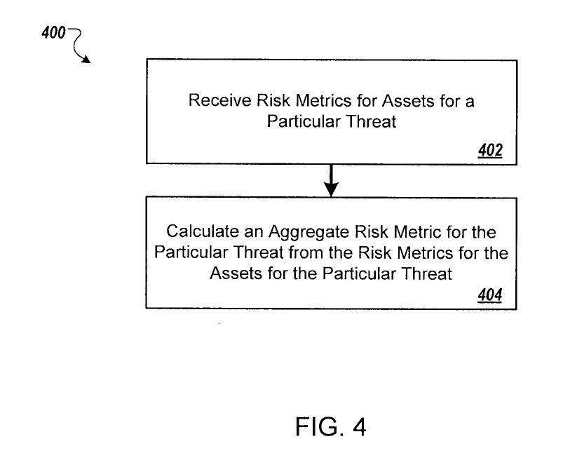

FIG. 4 is a flow diagram of an example process 400 for aggregating risk metrics for assets on a per-threat basis. The process can be implemented, for example, by the network monitor 102.

The process receives risk metrics for assets for a particular threat (402). The risk metrics can be for all assets in a system of assets, or for all assets in a particular group of assets. Examples of asset groups are described above. The risk metrics for each asset for the particular threat can be calculated, for example, as described above with reference to FIG. 3.

The process calculates an aggregate risk metric for the particular threat from the risk metrics for the assets for the particular threat (404).

In some implementations, the aggregate risk metric is a sum of the risk metrics for the assets for the threat, e.g.:

$$T {\sum }_{n} \frac{{V}_{n}}{{C}_{n}} {A}_{n} ,$$

where n is the number of assets to which the threat is applicable, and Vₙ, Cₙ, and Aₙ are calculated as described above with reference to FIG. 3 for asset n.

The sum of the risk metrics is not range-bound; in other words, the sums for different assets will not necessarily be on the same scale. Therefore, in some implementations, other aggregate metrics that are range bound, such as maximum or mean, are used instead of the sum. For example, in other implementations, the aggregate risk metric is the mean risk metric for assets to which the threat is applicable, calculated by dividing the sum of the risk metrics for each asset to which the threat is applicable and the particular threat by the number of assets to which the threat is applicable. This division bounds the mean risk score to the same range of values that the individual risk metrics for the particular threat and the assets have.

As another example, in other implementations, the aggregate risk metric is the maximum risk metric from the risk metrics for assets to which the particular threat is applicable and the particular threat.

Other aggregate risk metrics, for example, median or mode, can also be used. In some implementations, the system generates multiple aggregate risk metrics for the particular threat. In some implementations, the system calculates the mean, median, mode, maximum, and minimum of the risk metrics for assets to which the particular threat is applicable and the particular threat, and then generates an overall risk metric by using the resulting values as input to a metric function. In some implementations, the function is derived through trial and error, where different structures of the function, and different coefficients of the function, are tested with experimental data, until an acceptable function is determined. Conventional techniques for selecting the coefficients of the function can be used, for example, regression spline and mathematical optimization.

§4.2 Example Process for Aggregating Risk Metrics on a Per-Asset Basis

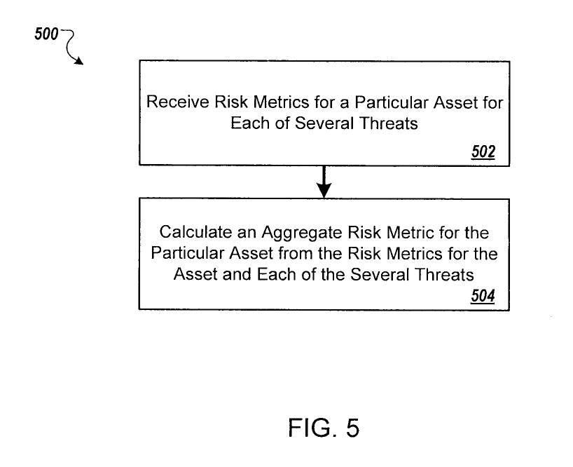

FIG. 5 is a flow diagram of an example process 500 for aggregating risk metrics on a per-asset basis. The process can be implemented, for example, by the network monitor 102.

The process receives risk metrics for a particular asset for each of several threats (502). The risk metrics for each asset for the particular threat can be calculated, for example, as described above with reference to FIG. 3.

The process calculates an aggregate risk metric for the particular asset from the risk metrics for the asset and each of the several threats (504). In some implementations, the aggregate risk metric is a sum of the risk metrics for the asset for the threats, e.g.,

$$A {\sum }_{m} {E}_{m} ,$$

where m is the number of threats that are applicable to the asset, and A and Eₘ are calculated as described above with reference to FIG. 3 for threat m.

The sum of the risk metrics is not range-bound; in other words, the sums for different assets will not necessarily be on the same scale. Therefore, in some implementations, other aggregate metrics that are range bound, such as maximum or mean, are used instead of the sum. For example, in other implementations, the aggregate risk metric is the mean risk metric for threats that are applicable to the asset. The mean risk metric is calculated by dividing the sum of the risk metrics for the asset and threats that are applicable to the asset by the number of threats that are applicable to the asset. This division bounds the mean risk score to the same range of values that the individual risk metrics for the particular threat and the assets have.

As another example, in other implementations, the aggregate risk metric is the maximum risk metric from the risk metrics for the asset and threats that are applicable to the asset.

Other aggregate risk metrics, for example, median or mode, can also be used. In some implementations, the system generates multiple aggregate risk metrics for the particular threat. In some implementations, the system calculates the mean, median, mode, maximum, and minimum of the risk metrics for assets to which the particular threat is applicable and the particular threat, and then generates an overall risk metric by using the resulting values as input to a metric function.

§4.3 Example Process for Aggregating Risk Metrics on an Asset Group Basis

In some implementations, the network monitor 102 aggregates the risk metrics for groups of assets. The assets can be grouped, for example, as described above. The system can then calculate the aggregate risk metric for each asset in the group and combine the aggregate risk metrics using various statistical techniques, e.g., mean, maximum, mean, median, mode, or minimum.

### §5.0 Example Uses of Risk Metrics

Once the network monitor 102 calculates the risk metrics, and aggregated risk metrics, as described above, the risk metrics and aggregated risk metrics can be used in various ways.

In some implementations, the network monitor 102 allows users to view assets, or threats, sorted by the aggregate risk metric for the asset, or threat. For example, the network monitor 102 can list all assets or threats, sorted by aggregate risk metric, or can list a top number, e.g., top ten, of the assets or threats. Ranking assets and threats according to the aggregate risk score allows a user to quickly identify which assets are most at risk, or which threats are most dangerous for a system. The user can then remediate the most at-risk assets before remediating other less-at-risk assets, or can apply remediations across the system for the riskiest threats before applying remediations for other, less-risky threats.

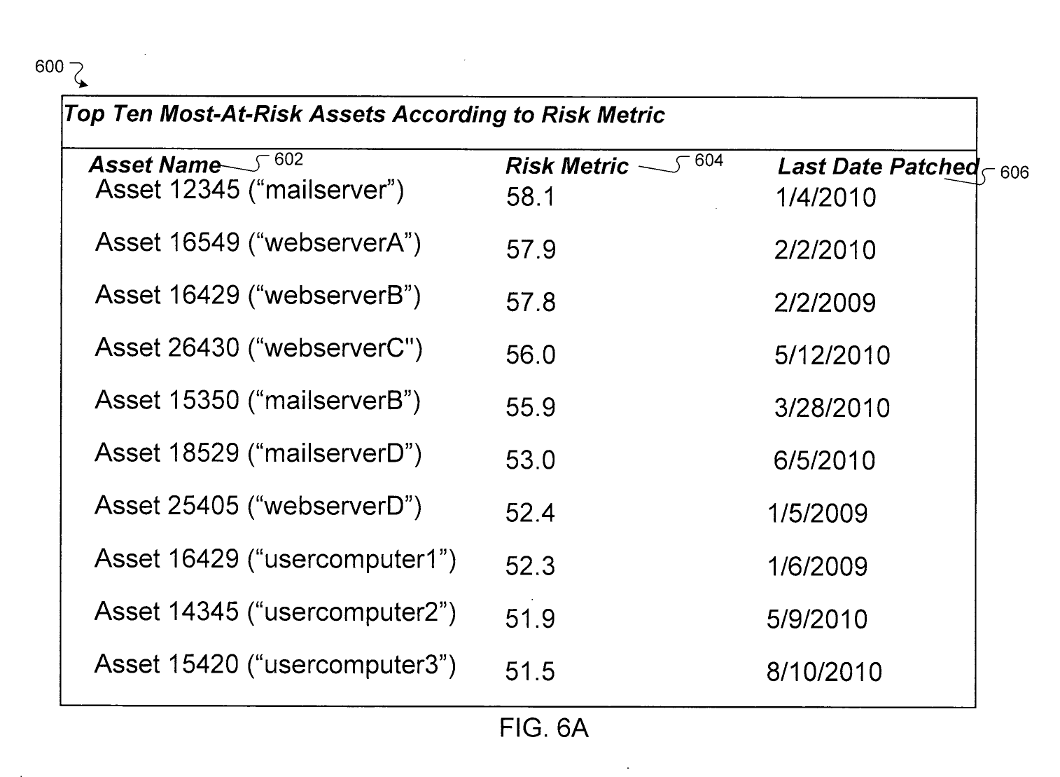

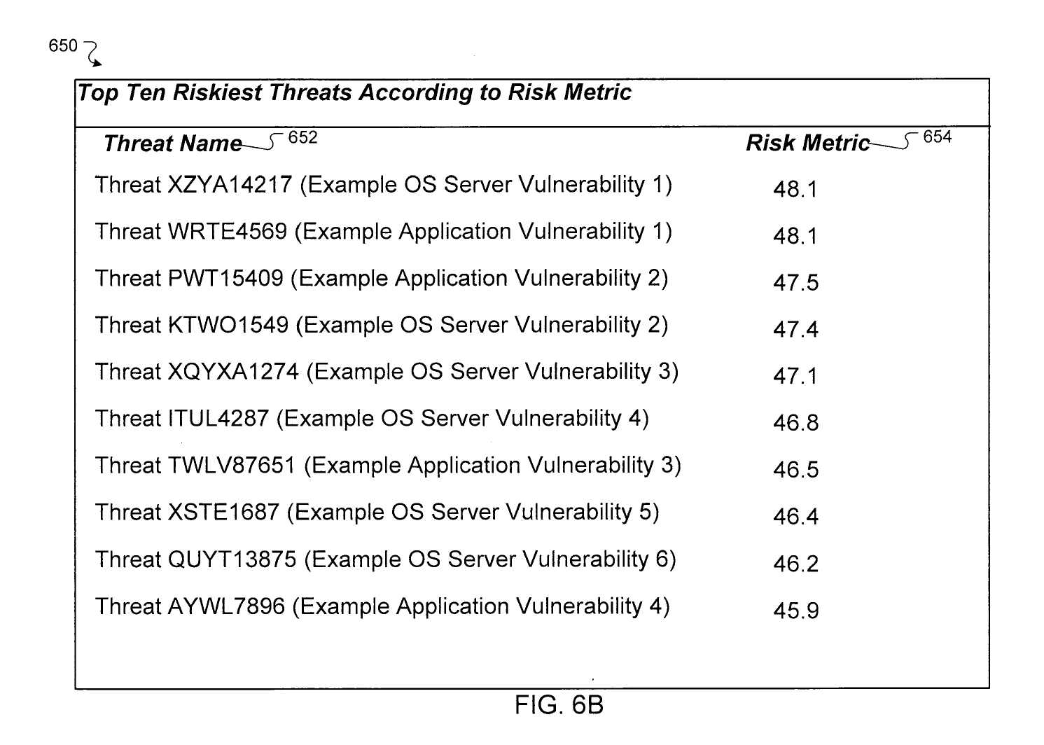

FIG. 6A is an example user interface 600 presenting the top ten most at-risk assets according to the aggregate risk metric for the assets. The user interface lists the names of the assets 602, sorted by aggregate risk metric as well as the aggregate risk metrics 604 themselves. The user interface can optionally include additional information about the assets. For example, in FIG. 6A, the last date the asset was patched 606 is shown. Other information about the asset can alternatively, or additionally, be displayed in the user interface. In some implementations, a user can click on the name of an asset to be provided with additional information about the asset.

FIG. 6B is an example user interface 650 presenting the top ten riskiest threats according to the aggregate risk metric for the threats. The user interface lists the names of the threats 652, sorted by aggregate risk metric as well as the aggregate risk metrics 654 themselves. The user interface can optionally include additional information about the threats, for example, when the threat was first announced, whether a remediation is available, or when a remediation was first made available. In some implementations, a user can click on the name of a threat to be provided with additional information about the threat.

The aggregate risk metrics for assets and threats can be used in other ways. For example, in some implementations, users can set rules that associate particular aggregate risk metrics with particular actions. For example, a user can specify that if an aggregate risk metric for any threat rises above a specified threshold, the user should be alerted. Similarly, a user can specify that if an aggregate risk metric for any asset rises above a specified threshold, the user should be alerted. The user can also use rules to filter what data the user views. For example, the user can request to only view information for assets, or threats, having an aggregate risk metric above a specified threshold.

In some implementations, the network monitor 102 receives queries from users specifying a particular risk metric range, identifies assets or threats satisfying the query, and presents the identified assets or threats to the user.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system, comprising:
a processor; and
a computer storage medium coupled to the processor and including instructions, which, when executed by the processor, cause the processor to perform operations comprising:
receiving threat definition data, the threat definition data including, for each of a plurality of threats, an identification of the threat, an identification of one or more countermeasures that reduce a risk that the threat will affect an asset, protection data describing a protection score for each countermeasure for the threat, and applicability data describing one or more configurations of assets to which the threat applies;
receiving vulnerability detection data, countermeasure detection data, and configuration data for each of one or more assets, wherein the vulnerability detection data for each asset identifies threats to which the asset is vulnerable, the countermeasure detection data for each asset identifies one or more countermeasures protecting the asset, and the configuration data for each asset describes a configuration of the asset; and
determining a respective risk metric for each of the one or more assets for each of the one or more threats, the determining including, for each asset and each threat:
determining an applicability score for the asset and the threat from the applicability data and the configuration data, wherein the applicability score has a first applicability value when the threat is applicable to the configuration of the asset and a different second applicability value when the threat is not applicable to the configuration of asset;
determining a vulnerability score for the asset and the threat from the vulnerability detection data for the asset, wherein the vulnerability score has a first vulnerability value when the asset is vulnerable to the threat, a second vulnerability value when the asset is not vulnerable to the threat, and a third vulnerability value when it is unknown whether the asset is vulnerable to the threat;
determining a countermeasure score from the threat definition data and the countermeasure detection data, wherein the generating comprises analyzing the protection score for each countermeasure that is both identified in the threat definition data for the threat and identified in the countermeasure data as protecting the asset, wherein the countermeasure score has a value within a predefined range; and
determining the risk metric for the particular asset for the particular threat from the applicability score, the vulnerability score, and the countermeasure score.

2. The system of claim 1, wherein the threat definition data further includes a severity score for the threat, and wherein the risk metric is further determined from the severity score.

3. The system of claim 1, wherein the operations further comprise receiving asset criticality data for each of the one or more assets, wherein:
the asset criticality data represents an impact of losing the asset;
determining the respective risk metric for each of the one or more assets further comprises deriving a criticality score for each asset from the asset criticality data; and
the risk metric is further determined from the criticality score.

4. The system of claim 3, wherein the criticality score is derived from a monetary value of the asset or a business value of the asset.

5. The system of claim 1, wherein determining the risk metric from the applicability score, the vulnerability score, and the countermeasure score comprises:
determining a threat factor from the applicability score;
determining an exposure factor from the threat factor, the vulnerability score, and the countermeasure score; and
determining the risk metric from the exposure factor.

6. The system of claim 1, wherein the operations further comprise:
determining a respective risk metric for the asset and each of a plurality of threats; and
determining an aggregate risk metric for the asset from the respective risk metrics for the asset and each of the plurality of threats.

7. The system of claim 6, wherein the aggregate risk metric is one of: a sum of the respective risk metrics, a mean of the respective risk metrics, a maximum of the respective risk metrics, a minimum of the respective risk metrics, or a mode of the respective risk metrics.

8. The system of claim 6, wherein the operations further comprise:
selecting a group of assets including the asset;
determining an aggregate risk metric for each asset in the group of assets; and
determining an aggregate risk metric for the group of assets from the aggregate risk metric for each asset in the group of assets.

9. The system of claim 1, wherein the operations further comprise:
determining a respective risk metric for each of a plurality of assets and the threat; and
determining an aggregate risk metric for the threat from the respective risk metrics for each of the plurality of assets and the threat.

10. The system of claim 1, wherein the predefined range for the countermeasure score is a discrete set of values.

11. The system of claim 1, wherein a threat is an attack represented by an individual threat vector.

12. The system of claim 1, wherein a threat corresponds to multiple threat vectors.

13. The system of claim 1, wherein the risk metric is further determined according to one or more user-specified weights.

14. A system, comprising:
a processor; and
a computer storage medium coupled to the processor and including instructions, which, when executed by the processor, cause the processor to perform operations comprising:
determining a threat factor for an asset and a threat, wherein the threat factor is derived from a threat severity score estimating a severity of the threat and an applicability score estimating the applicability of the threat to the asset;
determining an exposure factor for the asset and the threat, wherein the exposure factor is derived from the threat factor, a vulnerability score, and a countermeasure component score, wherein the vulnerability score indicates whether the asset is vulnerable to the threat, not vulnerable to the threat, or of unknown vulnerability to the threat, and wherein the countermeasure component score is derived from an estimate of a likelihood that the countermeasure will mitigate the effect of an attack on the asset; and
determining a risk metric for the asset and the threat from the exposure factor an a criticality score for the asset, wherein the criticality score represents an impact of losing the asset.

15. The system of claim 14, wherein the operations further comprise:
receiving threat definition data, the threat definition data including an identification of the threat, an identification of one or more countermeasures that reduce a risk that the threat will affect an asset, a severity score for the threat, protection data describing a protection score for each countermeasure for the threat, and applicability data describing one or more configurations of assets to which the threat applies; and
receiving vulnerability detection data, countermeasure detection data, configuration data, and criticality data for the asset, wherein the vulnerability detection data for the asset identifies threats to which the asset is vulnerable, the countermeasure detection data for the asset identifies one or more countermeasures protecting the asset, the configuration data for each asset describes a configuration of the asset, and the criticality data estimates a criticality of the asset.

16. The system of claim 15, wherein the operations further comprise determining the threat severity score from the threat definition data.

17. The system of claim 15, wherein the operations further comprise determining the applicability score from the applicability data and the configuration data.

18. The system of claim 15, wherein the operations further comprise determining the countermeasure score from the threat definition data and the countermeasure detection data, wherein the determining includes analyzing the protection score for each countermeasure that is both identified in the threat definition data for the threat and identified in the countermeasure data as protecting the asset.

19. The system of claim 15, wherein the operations further comprise determining the vulnerability score from the vulnerability detection data.

20. The system of claim 14, wherein the criticality score is derived from a monetary value of the asset or a business value of the asset.

21. A computer-implemented method, performed by data processing apparatus, comprising:
receiving threat definition data, the threat definition data including, for each of a plurality of threats, an identification of the threat, an identification of one or more countermeasures that reduce a risk that the threat will affect an asset, protection data describing a protection score for each countermeasure for the threat, and applicability data describing one or more configurations of assets to which the threat applies;
receiving vulnerability detection data, countermeasure detection data, and configuration data for each of one or more assets, wherein the vulnerability detection data for each asset identifies threats to which the asset is vulnerable, the countermeasure detection data for each asset identifies one or more countermeasures protecting the asset, and the configuration data for each asset describes a configuration of the asset; and
determining a respective risk metric for each of the one or more assets for each of the one or more threats, the determining including, for each asset and each threat:
determining an applicability score for the asset and the threat from the applicability data and the configuration data, wherein the applicability score has a first applicability value when the threat is applicable to the configuration of the asset and a different second applicability value when the threat is not applicable to the configuration of asset;
determining a vulnerability score for the asset and the threat from the vulnerability detection data for the asset, wherein the vulnerability score has a first vulnerability value when the asset is vulnerable to the threat, a second vulnerability value when the asset is not vulnerable to the threat, and a third vulnerability value when it is unknown whether the asset is vulnerable to the threat;
determining a countermeasure score from the threat definition data and the countermeasure detection data, wherein the generating comprises analyzing the protection score for each countermeasure that is both identified in the threat definition data for the threat and identified in the countermeasure data as protecting the asset, wherein the countermeasure score has a value within a predefined range; and
determining the risk metric for the particular asset for the particular threat from the applicability score, the vulnerability score, and the countermeasure score.

22. The method of claim 21, wherein the threat definition data further includes a severity score for the threat, and wherein the risk metric is further determined from the severity score.

23. The method of claim 21, further comprising receiving asset criticality data for each of the one or more assets, wherein:
the asset criticality data represents an impact of losing the asset;
determining the respective risk metric for each of the one or more assets further comprises deriving a criticality score for each asset from the asset criticality data; and
the risk metric is further determined from the criticality score.

24. The method of claim 21, further comprising:
determining a respective risk metric for the asset and each of a plurality of threats; and
determining an aggregate risk metric for the asset from the respective risk metrics for the asset and each of the plurality of threats.

25. The method of claim 21, further comprising:
determining a respective risk metric for each of a plurality of assets and the threat; and
determining an aggregate risk metric for the threat from the respective risk metrics for each of the plurality of assets and the threat.

26. A computer-implemented method, performed by data processing apparatus, comprising
determining a threat factor for an asset and a threat, wherein the threat factor is derived from a threat severity score estimating a severity of the threat and an applicability score estimating the applicability of the threat to the asset;
determining an exposure factor for the asset and the threat, wherein the exposure factor is derived from the threat factor, a vulnerability score, and a countermeasure component score, wherein the vulnerability score indicates whether the asset is vulnerable to the threat, not vulnerable to the threat, or of unknown vulnerability to the threat, and wherein the countermeasure component score is derived from an estimate of a likelihood that the countermeasure will mitigate the effect of an attack on the asset; and
determining a risk metric for the asset and the threat from the exposure factor an a criticality score for the asset, wherein the criticality score represents an impact of losing the asset.

27. The method of claim 26, further comprising:
receiving threat definition data, the threat definition data including an identification of the threat, an identification of one or more countermeasures that reduce a risk that the threat will affect an asset, a severity score for the threat, protection data describing a protection score for each countermeasure for the threat, and applicability data describing one or more configurations of assets to which the threat applies; and
receiving vulnerability detection data, countermeasure detection data, configuration data, and criticality data for the asset, wherein the vulnerability detection data for the asset identifies threats to which the asset is vulnerable, the countermeasure detection data for the asset identifies one or more countermeasures protecting the asset, the configuration data for each asset describes a configuration of the asset, and the criticality data estimates a criticality of the asset.

28. The method of claim 27, further comprising determining the threat severity score from the threat definition data, determining the applicability score from the from the applicability data and the configuration data, determining the vulnerability score from the vulnerability detection data, and determining the countermeasure score from the threat definition data and the countermeasure detection data.

29. A computer-storage medium encoded with a computer program including instructions operable to cause data processing apparatus to perform operations comprising:
receiving threat definition data, the threat definition data including, for each of a plurality of threats, an identification of the threat, an identification of one or more countermeasures that reduce a risk that the threat will affect an asset, protection data describing a protection score for each countermeasure for the threat, and applicability data describing one or more configurations of assets to which the threat applies;
receiving vulnerability detection data, countermeasure detection data, and configuration data for each of one or more assets, wherein the vulnerability detection data for each asset identifies threats to which the asset is vulnerable, the countermeasure detection data for each asset identifies one or more countermeasures protecting the asset, and the configuration data for each asset describes a configuration of the asset; and
determining a respective risk metric for each of the one or more assets for each of the one or more threats, the determining including, for each asset and each threat:
determining an applicability score for the asset and the threat from the applicability data and the configuration data, wherein the applicability score has a first applicability value when the threat is applicable to the configuration of the asset and a different second applicability value when the threat is not applicable to the configuration of asset;
determining a vulnerability score for the asset and the threat from the vulnerability detection data for the asset, wherein the vulnerability score has a first vulnerability value when the asset is vulnerable to the threat, a second vulnerability value when the asset is not vulnerable to the threat, and a third vulnerability value when it is unknown whether the asset is vulnerable to the threat;
determining a countermeasure score from the threat definition data and the countermeasure detection data, wherein the generating comprises analyzing the protection score for each countermeasure that is both identified in the threat definition data for the threat and identified in the countermeasure data as protecting the asset, wherein the countermeasure score has a value within a predefined range; and
determining the risk metric for the particular asset for the particular threat from the applicability score, the vulnerability score, and the countermeasure score.

30. A computer-storage medium encoded with a computer program including instructions operable to cause data processing apparatus to perform operations comprising:
determining a threat factor for an asset and a threat, wherein the threat factor is derived from a threat severity score estimating a severity of the threat and an applicability score estimating the applicability of the threat to the asset;
determining an exposure factor for the asset and the threat, wherein the exposure factor is derived from the threat factor, a vulnerability score, and a countermeasure component score, wherein the vulnerability score indicates whether the asset is vulnerable to the threat, not vulnerable to the threat, or of unknown vulnerability to the threat, and wherein the countermeasure component score is derived from an estimate of a likelihood that the countermeasure will mitigate the effect of an attack on the asset; and
determining a risk metric for the asset and the threat from the exposure factor an a criticality score for the asset, wherein the criticality score represents an impact of losing the asset.
